(19) United States
(12) Patent Application Publication
(10) Pub. No.: US 2023/0159775 A1
(43) Pub. Date: May 25, 2023

(54) INKJET INK

(71) Applicant: KYOCERA Document Solutions Inc., Osaka (JP)

(72) Inventor: Katsuki OSANISHI, Osaka-shi (JP)

(73) Assignee: KYOCERA Document Solutions Inc., Osaka (JP)

(21) Appl. No.: 18/056,688

(22) Filed: Nov. 17, 2022

(30) Foreign Application Priority Data
Nov. 19, 2021 (JP) 2021-188690

(51) Int. Cl. C09D 11/322; C08F 220/06; C08F 220/18; C09D 11/107

(52) U.S. Cl. CPC C09D 11/322; C08F 220/06; C08F 220/1807; C09D 11/107

(57) ABSTRACT

An inkjet ink contains a pigment, a specific polymer, a water-soluble organic solvent, and water. The specific polymer includes at least one first repeating unit, at least one second repeating unit, at least one third repeating unit, and at least one fourth repeating unit. The first repeating unit is a repeating unit derived from a monomer having a salt-forming group. The second repeating unit is a repeating unit derived from a styrene-based monomer. The third repeating unit is a repeating unit derived from a styrene-based macromer having a polymerizable functional group at one end thereof. The fourth repeating unit is a repeating unit derived from nonionic acrylic acid ester or nonionic methacrylic acid ester.

### INCORPORATION BY REFERENCE

The present application claims priority under 35 U.S.C. § 119 to Japanese Patent Application No. 2021-188690, filed on Nov. 19, 2021. The contents of this application are incorporated herein by reference in their entirety.

### BACKGROUND

The present disclosure relates to an inkjet ink.

Ejection of an inkjet ink toward a recording medium from a nozzle of a recording head of an inkjet recording apparatus forms an image on the recording medium. Studies are continued for an inkjet ink that can form images with desired image density and excellent scratch resistance on a recording medium. An example of such an inkjet ink is an aqueous medium containing a pigment and a microemulsion.

### SUMMARY

An inkjet ink according to an aspect of the present disclosure includes a pigment, a specific polymer, a water-soluble organic solvent, and water. The specific polymer includes at least one first repeating unit, at least one second repeating unit, at least one third repeating unit, and at least one fourth repeating unit. The first repeating unit is a repeating unit derived from a monomer having a salt-forming group. The second repeating unit is a repeating unit derived from a styrene-based monomer. The third repeating unit is a repeating unit derived from a styrene-based macromer having a polymerizable functional group at one end thereof. The fourth repeating unit is a repeating unit derived from nonionic acrylic acid ester or nonionic methacrylic acid ester. The first repeating unit has a percentage content of at least 11% by mass and no greater than 35% by mass to a mass of the specific polymer. The water-soluble organic solvent includes 1,2-pentanediol and 3-methyl-1,3-butanediol. A total percentage content of the 1,2-pentanediol and the 3-methyl-1,3-butanediol is at least 10% by mass and no greater than 30% by mass to a mass of the inkjet ink.

### DETAILED DESCRIPTION

The following describes an embodiment of the present disclosure. First of all, the terms used in the present specification will be explained. Values for number average molecular weight (Mn) and mass average molecular weight (Mw) are values as measured by gel permeation chromatography unless otherwise stated. Values for cumulative value at 50% (also referred to below as “D₅₀”) and cumulative value at 90% (also referred to below as “D₉₀”) in a particle size distribution in terms of volume are values as measured using a dynamic light scattering type particle size distribution analyzer (“ZETASIZER NANO ZS”, product of Malvern Instruments Ltd.) unless otherwise stated. In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. The term “(meth)acryl” is used as a generic term for both acryl and methacryl. The term “(meth)acrylate” is used as a generic term for both acrylate and methacrylate. The phrase “each represent, independently of one another,” in description about formulas means possibly representing the same group or different groups. The terms “alkyl group” and “alkanediyl group” in description about formulas each are an unsubstituted straight chain or branched chain group unless otherwise stated. One type of each component described in the present specification may be used independently, or two or more types of the component may be used in combination.

The terms used in the present specification have been explained so far.

<Ink>

The following describes an inkjet ink (also referred to below simply as ink) according to an embodiment of the present disclosure. The ink of the present embodiment contains a pigment, a specific polymer, a water-soluble organic solvent, and water. The specific polymer includes at least one first repeating unit, at least one second repeating unit, at least one third repeating unit, and at least one fourth repeating unit. The first repeating unit is a repeating unit derived from a monomer having a salt-forming group. The second repeating unit is a repeating unit derived from a styrene-based monomer. The third repeating unit is a repeating unit derived from a styrene-based macromer having a polymerizable functional group at one end thereof. The fourth repeating unit is a repeating unit derived from nonionic acrylic acid ester or nonionic methacrylic acid ester. The first repeating unit has a percentage content of at least 11% by mass and no greater than 35% by mass to the mass of the specific polymer. The water-soluble organic solvent includes 1,2-pentanediol and 3-methyl-1,3-butanediol. The total percentage content of the 1,2-pentanediol and the 3-methyl-1,3-butanediol is at least 10% by mass and no greater than 30% by mass to the mass of the ink.

In the following, a “percentage content of the first repeating unit to the mass of the specific polymer” may be referred to as “first unit percentage”. Also, “1,2-pentanediol and 3-methyl-1,3-butanediol” may each be referred to as “specific solvent”. The “total percentage content of the 1,2-pentanediol and the 3-methyl-1,3-butanediol to the mass of the ink” may be referred to as “specific solvent percentage content”. The term “aqueous medium” may be used as a generic term for “water and water-soluble organic solvent”.

As a result of having the above features, the ink of the present embodiment can have excellent ejection stability from a recording head and can form images with desired image density and excellent scratch resistance. The reasons thereof can be inferred as follows.

The specific polymer contained in the ink of the present embodiment is attached to the surface of the pigment, for example. The attached specific polymer and the pigment constitute pigment particles. As a result of the specific polymer being attached to the pigment, the pigment particles are favorably dispersed in the aqueous medium. Typically, when the polymer attached to the surface of the pigment has excessively low hydrophobicity, it is difficult for the pigment particles to aggregate in the aqueous medium with a result that image density of images formed with use of the ink is lower than desired image density. By contrast, when the polymer attached to the surface of the pigment has excessively high hydrophobicity, the pigment particles excessively aggregate in the aqueous medium with a result that scratch resistance of images formed with use of the ink and ejection stability of the ink from the recording head decrease. Here, the specific polymer contained in the ink of the present embodiment has the above composition and accordingly is moderately hydrophobic. Therefore, the pigment particles are favorably dispersed in the aqueous medium in a moderately aggregated state. As a result, the ink of the present embodiment can achieve both excellent ejection stability from the recording head and formation of images with desired image density and excellent scratch resistance.

Furthermore, the specific solvent percentage content of the ink of the present embodiment is at least 10% by mass and no greater than 30% by mass. Of the specific solvents, the 1,2-pentanediol tends to decrease surface tension of the ink, for example. Of the specific solvents, the 3-methyl-1,3-butanediol tends to increase viscosity of the ink, for example. Furthermore, the 3-methyl-1,3-butanediol tends to aggregate the pigment particles when the ink once ejected from the recording head toward a recording medium dries. As a result of the specific solvent percentage content being set to at least 10% by mass and no greater than 30% by mass, surface tension and viscosity of the ink of the present embodiment and the degree of aggregation of the pigment particles in ink drying can be adjusted within respective desired ranges. The ink having desired surface tension and viscosity can moderately penetrate into a recording medium. When the degree of aggregation of the pigment particles in ink drying is within the desired range, the pigment particles do not aggregate excessively on the recording medium and separation of the pigment particles from the recording medium due to scratching of the recording medium can be inhibited. As a result of the above, the ink can form images with excellent scratch resistance. Furthermore, as a result of the ink having desired surface tension and desired viscosity and the pigment particles having an appropriate degree of aggregation in ink drying, the pigment particles can moderately stay on the surface of the recording medium in a moderately aggregated state. As a result, the ink can form images with desired image density. In addition, as a result of having desired surface tension and desired viscosity, the ink can be stably ejected from the recording head.

The ink of the present embodiment will be described further in detail.

<Pigment>

The pigment of the ink of the present embodiment constitutes pigment particles together with the specific polymer, for example. The pigment particles are each constituted by a core containing the pigment and the specific polymer attached to the surface of the core. The specific polymer of the pigment particles preferably covers the cores. From the viewpoint of optimization of color density, hue, and preservation stability of the ink of the present embodiment, the pigment particles have a D₅₀ of preferably at least 30 nm and no greater than 200 nm, and more preferably at least 70 nm and no greater than 130 nm. The D₅₀ of the pigment particles can be measured using a dynamic light scattering type particle size distribution analyzer (e.g., “ZETASIZER NANO ZS”, product of Malvern Instruments Ltd.) with use of a solution obtained by diluting a dispersion of the pigment 300 times with ion exchange water as a sample.

Examples of the pigment include a yellow pigment, an orange pigment, a red pigment, a blue pigment, a violet pigment, and a black pigment. Examples of the yellow pigment include C.I. Pigment Yellow (74, 93, 95, 109, 110, 120, 128, 138, 139, 151, 154, 155, 173, 180, 185, or 193). Examples of the orange pigment include C.I. Pigment Orange (34, 36, 43, 61, 63, or 71). Examples of the red pigment include C.I. Pigment Red (122 or 202). Examples of the blue pigment include C.I. Pigment Blue (15, specifically, 15:3). Examples of the violet pigment include C.I. Pigment Violet (19, 23, or 33). Examples of the black pigment include C.I. Pigment Black (7) and carbon black.

Preferably, the pigment has a percentage content of at least 1% by mass and no greater than 15% by mass to the mass of the ink. As a result of the percentage content of the pigment being set to at least 1% by mass, images with desired image density can be further easily formed with use of the ink. As a result of the percentage content of the pigment being set to no greater than 15.0% by mass by contrast, fluidity of the ink can be optimized.

<Specific Polymer>

As described previously, the specific polymer includes at least one first repeating unit, at least one second repeating unit, at least one third repeating unit, and at least one fourth repeating unit. The monomer (styrene-based macromer having a polymerizable functional group at one end thereof) forming the third repeating unit has a moiety (also referred to below as polymerizable functional group moiety) of the polymerizable functional group and a moiety (also referred to below as side chain moiety) other than the polymerizable functional group moiety. The specific polymer has a main chain and a side chain. The main chain of the specific polymer is constituted by the first repeating unit, the second repeating unit, a portion derived from the polymerizable functional group moiety of the third repeating unit, and the fourth repeating unit. The side chain of the specific polymer is constituted by the side chain moiety of the third repeating unit. Note that no particular limitations are placed on the sequence of the repeating units (1), (2), (3), and (4) in the main chain of the specific polymer.

Preferably, the specific polymer is in an emulsified particle form. When the specific polymer is in an emulsified particle form, the emulsified particles of the specific polymer disperse in the aqueous medium. Due to the first repeating unit of the specific polymer having a salt-forming group, the specific polymer can be sufficiently emulsified and dispersed in the aqueous medium by neutralizing the salt-forming group using a neutralizer. The emulsified particles of the specific polymer preferably constitute the pigment particles together with the pigment.

(Log P of Specific Polymer)

An octanol-water partition coefficient Log P (specifically, 1-octanol-water partition coefficient Log P) refers to a logarithm of an octanol-water partition coefficient. In the following, the “octanol-water partition coefficient Log P” may be referred to simply as “Log P”. The Log P is a value used for prediction of hydrophobicity (or hydrophilicity) of a substance. The larger the Log P of a substance is, the higher the hydrophobicity of the substance is.

The Log P of a substance can be calculated based on fragment approach using a program (SRC's LOGKOW/KOWWIN Program) of software (“KowWin”, product of System Research Center Co., LTD.), for example. In the following, “SRC's LOGKOW/KOWWIN Program” may be referred to as “Log P calculating program”. The Log P calculating program is configured according to the method described in “Atom/fragment contribution method for estimating octanol-water partition coefficients”, by Meylan, W. M. and P. H. Howard, J. Pharm. Sci., 1995, Vol. 84, pp. 83-92.

The specific polymer of the ink of the present embodiment has a Log P of preferably at least 2.0 and no greater than 4.0, and more preferably at least 2.5 and no greater than 3.0. As a result of the Log P of the specific polymer being set to at least 2.0, the specific polymer can have relatively high hydrophobicity and the pigment particles (pigment with the specific polymer attached thereto) can aggregate moderately in the aqueous medium. As a result, the ink can form images with desired image density. As a result of the Log P of the specific polymer being set to no greater than 4.0 by contrast, the specific polymer can have relatively low hydrophobicity and the pigment particles do not excessively aggregate in the aqueous medium. As a result, the ink can form images with excellent scratch resistance and can be stably ejected from the recording head.

The Log P of the specific polymer can be calculated by the following method. First, the Log P of each monomer forming the repeating units of the specific polymer is calculated using the Log P calculating program. With respect to each monomer, a value (Log Pm×Rm) is calculated by multiplying a Log P (Log Pm) of the monomer by a mole fraction (Rm) of the corresponding repeating unit derived from the monomer in the specific polymer. The value obtained by summing up all the calculated values (Log Pm×Rm) of the monomers is taken to be a Log P of the specific polymer. For example, where the specific polymer is formed from monomers A to D, a Log P of the specific polymer is calculated using a formula “Log P of specific polymer=[(Log P of monomer A)×(mole fraction R_{A} of repeating unit derived from monomer A)]+[(Log P of monomer B)×(mole fraction R_{B} of repeating unit derived from monomer B)]+[(Log P of monomer C)×(mole fraction R_{C} of repeating unit derived from monomer C)]+[(Log P of monomer D)×(mole fraction RD of repeating unit derived from monomer D)]. The total of the mole fractions R_{A}, R_{B}, R_{C}, and RD is 100%. Note that in a case in which a chain transfer agent and an initiator are used for synthesis of the specific polymer, the Log P of each of the chain transfer agent and the initiator is not taken into consideration. In addition, in a case in which the first repeating unit is neutralized, the calculation uses the Log P of the monomer forming the first monomer before neutralization.

In order to impart moderate hydrophilicity to the specific polymer, the Log P of the monomer forming the first repeating unit is preferably at least −1.00 and no greater than 1.00. In order to impart moderate hydrophobicity to the specific polymer, the Log P of the monomer forming the third repeating unit is preferably at least 100 and no greater than 200. In order to balance the hydrophilicity with the hydrophobicity of the specific polymer, the Log P of the monomer forming the second repeating unit and the Log P of the monomer forming the fourth repeating unit each are preferably at least 1.10 and no greater than 5.00.

(First Repeating Unit)

The first repeating unit is a repeating unit derived from a monomer having a salt-forming group. The salt-forming group is hydrophilic. The first repeating unit having a hydrophilic salt-forming group imparts hydrophilicity to the specific polymer. Accordingly, the pigment particles sufficiently disperse in the aqueous medium. Furthermore, since moderate hydrophilicity is imparted to the specific polymer, the specific polymer can have moderate hydrophobicity with a result that the pigment particles do not excessively aggregate in the aqueous medium. As a result, images with excellent scratch resistance can be formed with use of the ink and the ink can be stably ejected from the recording head.

Examples of the salt-forming group include an anionic salt-forming group and a cationic salt-forming group. Examples of the anionic salt-forming group includes a carboxy group, a sulfo group, and a phospho group. Examples of the cationic salt-forming group include an amino group and a —NH₄⁺ group. The salt-forming group is preferably a carboxy group.

Examples of the monomer (monomer having a salt-forming group) forming the first repeating unit include a monomer having an anionic salt-forming group and a monomer having a cationic salt-forming group.

Examples of the monomer having an anionic salt-forming group include an unsaturated carboxylic acid monomer, an unsaturated sulfonic acid monomer, and an unsaturated phosphoric acid monomer. Examples of the unsaturated carboxylic acid monomer include acrylic acid, methacrylic acid, crotonic acid, itaconic acid, maleic acid, fumaric acid, citraconic acid, and 2-methacryloyloxymethylsuccinic acid. Examples of the unsaturated sulfonic acid monomer include styrene sulfonic acid, 2-acrylamide-2-methylpropanesulfonic acid, 3-sulfopropyl(meth)acrylic acid ester, and bis-(3-sulfopropyl)-itaconic acid ester. Examples of the unsaturated phosphoric acid monomer include vinyl phosphonic acid, vinyl phosphate, bis(methacryloxyethyl)phosphate, diphenyl-2-acryloyloxyethyl phosphate, diphenyl-2-methacryloyloxyethyl phosphate, and dibutyl-2-acryloyloxyethyl phosphate. From the viewpoint of optimization of viscosity of the ink and the viewpoint of favorable ejection stability of the ink from the recording head, the monomer having an anionic salt-forming group is preferably an unsaturated carboxylic acid monomer, and more preferably acrylic acid, methacrylic acid, itaconic acid, or maleic acid.

Examples of the monomer having a cationic salt-forming group include a vinyl monomer having a substituted amino group and a quaternary ammonium salt monomer having a vinyl group. Examples of the vinyl monomer having a substituted amino group include N,N-dimethylaminoethyl (meth)acrylate, N,N-dimethylaminopropyl (meth)acrylate, N,N-diethylaminoethyl (meth)acrylate, N,N-dimethylaminopropyl (meth)acrylamide, vinyl pyrrolidone, 2-vinyl pyridine, 4-vinyl pyridine, 2-methyl-6-vinylpyridine, and 5-ethyl-2-vinylpyridine. Examples of the quaternary ammonium salt monomer having a vinyl group include N,N-dimethylaminoethyl (meth)acrylate quaternary, N,N-diethylaminoethyl (meth)acrylate quaternary, and N,N-dimethylaminopropyl (meth)acrylate quaternary. Examples of the monomer having a cationic salt-forming group include N,N-dimethylaminoethyl (meth)acrylate, N,N-dimethylaminopropyl (meth)acrylamide, and vinyl pyrrolidone.

Preferably, the first repeating unit is represented by formula (1).

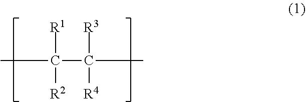

In formula (1), at least one of R¹, R², R³, and R⁴ each represent, independently of one another, a carboxy group or an alkyl group with a carbon number of at least 1 and no greater than 6 substituted with a carboxy group. The rest of R¹, R², R³, and R⁴ each represents, independently of one another, a hydrogen atom or a methyl group.

Preferably, one or two of R¹, R², R³, and R⁴ preferably represent a carboxy group or an alkyl group with a carbon number of at least 1 and no greater than 6 substituted with a carboxy group. Preferably, two or three of R¹, R², R³, and R⁴ each represent, independently of one another, a hydrogen atom or a methyl group. The alkyl group with a carbon number of at least 1 and no greater than 6 substituted with a carboxy group is preferably an alkyl group with a carbon number of at least 1 and no greater than 3 substituted with a carboxy group, and more preferably a carboxymethyl group.

Preferable examples of formula (1) include formulas (1-1) to (1-4). The repeating unit represented by formula (1-1) is a repeating unit derived from methacrylic acid. The repeating unit represented by formula (1-2) is a repeating unit derived from acrylic acid. The repeating unit represented by formula (1-3) is a repeating unit derived from maleic acid. The repeating unit represented by formula (1-4) is a repeating unit derived from itaconic acid.

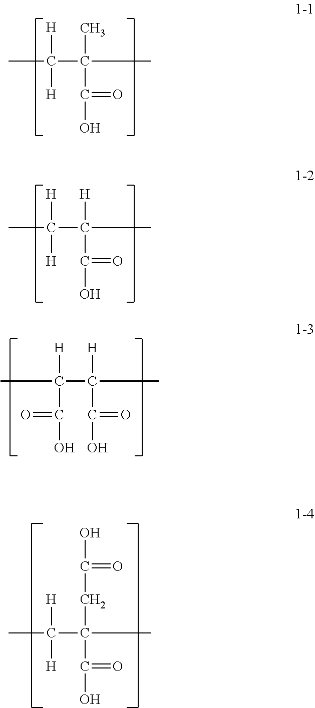

As described previously, the first unit percentage is at least 11% by mass and no greater than 35% by mass. From the viewpoint of sufficient dispersion of the pigment particles in the aqueous medium through impartment of moderate hydrophilicity to the specific polymer, the first unit percentage is preferably at least 11% by mass and no greater than 30% by mass, more preferably at least 11% by mass and no greater than 20% by mass, and further preferably at least 11% by mass and no greater than 15% by mass. Note that in a case in which the first repeating unit is neutralized, the first unit percentage is a percentage content of the first repeating unit before neutralization. The specific polymer includes preferably at least one and no greater than four first repeating units, and more preferably one or two repeating units. Note that where the specific polymer includes two or more first repeating units, the first unit percentage is the total percentage content of the two or more first repeating units.

(Second Repeating Unit)

The second repeating unit is a repeating unit derived from a styrene-based monomer. As a result of the specific polymer including the second repeating unit, preservation stability of the ink and scratch resistance of images formed with use of the ink can be optimized.

Examples of the monomer (styrene-based monomer) forming the second repeating unit include styrene, α-methylstyrene, and vinyltoluene.

Preferably, the second repeating unit is represented by formula (2).

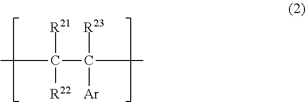

In formula (2), Ar represents a phenyl group optionally substituted with an alkyl group with a carbon number of at least 1 and no greater than 6, and R²¹, R²², and R²³ each represent, independently of one another, a hydrogen atom or a methyl group. The phenyl group optionally substituted with an alkyl group with a carbon number of at least 1 and no greater than 6 that is represented by Ar is preferably a phenyl group optionally substituted with an alkyl group with a carbon number of at least 1 and no greater than 3, more preferably a phenyl group optionally substituted with a methyl group, and further preferably a phenyl group.

A preferable example of formula (2) is formula (2-1). The repeating unit represented by formula (2-1) is a repeating unit derived from styrene.

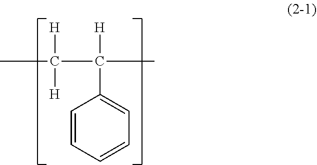

From the viewpoint of optimization of scratch resistance of images formed with use of the ink, the percentage content of the second repeating unit is preferably at least 10% by mass and no greater than 80% by mass to the mass of the specific polymer, more preferably at least 10% by mass and no greater than 70% by mass, further preferably at least 10% by mass and no greater than 60% by mass, still more preferably at least 10% by mass and no greater than 20% by mass, and particularly preferably at least 12% by mass and no greater than 17% by mass. The specific polymer includes preferably one or two second repeating units, and more preferably one second repeating unit. Note that where the specific polymer has two or more second repeating units, the percentage content of the second repeating unit is the total percentage content of the two or more second repeating units.

(Third Repeating Unit)

The third repeating unit is a repeating unit derived from a styrene-based macromer having a polymerizable functional group at one end thereof. As described previously, the styrene-based macromer has a polymerizable functional group moiety and a side chain moiety. The side chain moiety is hydrophobic. The hydrophobic side chain moiety has low affinity with the specific solvent, and accordingly orients to the pigment rather than to an aqueous medium including the specific solvent. Furthermore, the hydrophobic side chain moiety has high affinity with the pigment and firmly attaches to the pigment. The pigment particles with the specific polymer firmly attached thereto sufficiently disperse in the aqueous medium. As a result, the ink can have excellent preservation stability and excellent ejection stability from the recording head. Furthermore, the third repeating unit having the hydrophobic side chain moiety imparts moderate hydrophobicity to the specific polymer. As a result, the pigment particles moderately aggregate in the aqueous medium to achieve formation of images with desired image density with use of the ink.

Examples of the polymerizable functional group of the styrene-based macromer include a vinyl group, an acryloyloxy group, and a methacryloyloxy group. Preferably, the polymerizable functional group of the styrene-based macromer is a vinyl group. As a result of mutual polymerization of a plurality of styrene-based macromers or as a result of polymerization of the polymerizable functional group of the styrene-based macromere with the monomers forming the repeating units (1), (2), and (4), the specific polymer can be obtained that is a water-insoluble graft polymer.

In one example, the side chain moiety of the third repeating unit has a structure (e.g., a polystyrene chain) in which the repeating units derived from styrene-based monomer is repeated in series. Preferably, the styrene-based monomer forming the polystyrene chain is styrene. In another example, the side chain moiety of the third repeating unit has a structure in which the repeating unit derived from a styrene-based monomer and a repeating unit derived from a monomer other than the styrene-based monomer are arranged.

Where the side chain moiety of the third repeating unit has a polystyrene chain, the styrene-based monomer forming the polystyrene chain of the side chain moiety may be styrene, α-methylstyrene, or vinyltoluene, for example. Preferably, the styrene-based monomer forming the side chain moiety is styrene. The average degree of polymerization of the polystyrene chain is preferably at least 30 and no greater than 80, more preferably at least 50 and no greater than 60, and further preferably at least 54 and no greater than 55. The degree of polymerization of the polystyrene chain means the number of repeats the repeating unit derived from the styrene-based monomer in the polystyrene chain.

Examples of the monomer other than the styrene-based monomer forming the side chain moiety of the third repeating unit include an acrylonitrile monomer and a (meth)acrylic acid ester monomer. Examples of the (meth)acrylic acid ester monomer include (meth)acrylic acid alkyl ester and (meth)acrylic acid ester having an aromatic ring group. The (meth)acrylic acid alkyl ester is preferably (meth)acrylic acid alkyl ester having an alkyl group with a carbon number of at least 1 and no greater than 22, and more preferably (meth)acrylic acid alkyl ester having an alkyl group with a carbon number of at least 1 and no greater than 18. Examples of the (meth)acrylic acid ester having an aromatic ring group include (meth)acrylic acid ester having an aryl group with a carbon number of at least 6 and no greater than 22 and (meth)acrylic acid ester having an arylalkyl group with a carbon number of at least 7 and no greater than 22. An example of the (meth)acrylic acid ester having an aryl group with a carbon number of at least 6 and no greater than 22 is phenoxyethyl (meth)acrylate. An example of the (meth)acrylic acid ester having an arylalkyl group with a carbon number of at least 7 and no greater than 22 is benzyl (meth)acrylate.

From the viewpoint of formation of images with excellent scratch resistance with use of the ink, the percentage content of the repeating unit derived from a styrene-based monomer is preferably at least 60% by mass to the mass of the third repeating unit, more preferably at least 70% by mass, and further preferably at least 90% by mass.

Preferably, the third repeating unit is represented by formula (3). In formula (3), a moiety represented by “—CR³¹R³²—CR³³<” is the polymerizable functional group moiety of the third repeating unit and a moiety represented by Rs is the side chain moiety of the third repeating unit.

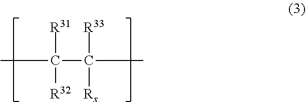

In formula (3), R³¹, R³², and R³³ each represent, independently of one another, a hydrogen atom or a methyl group. Rs represents a group with a polystyrene chain.

The group with a polystyrene chain represented by Rs is a group represented by formula (3s), for example.

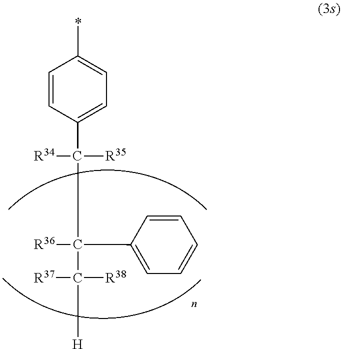

In formula (3s), R³⁴, R³⁵, R³⁶, R³⁷, and R³⁸ each represent, independently of one another, a hydrogen atom or a methyl group. * represents a bond, and specifically represents a bond that bonds to a carbon atom (carbon atom to which Rs is bonded) in formula (3). n represents the number of repeats. The number of repeats represented by n corresponds to the average degree of polymerization of the polystyrene chain. n represents preferably the number of at least 30 and no greater than 80, more preferably the number of at least 50 and no greater than 60, and further preferably the number of at least 54 and no greater than 55.

A preferable example of formula (3) is formula (3-1). n₁ in formula (3-1) is the same as defined for n in formula (3s).

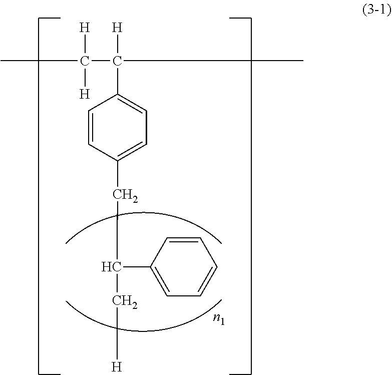

From the viewpoint of optimization of preservation stability and viscosity of the ink, the number average molecular weight of the third repeating unit and the number average molecular weight of the monomer (styrene-based macromer having a polymerizable functional group at one end thereof) forming the third repeating unit each are preferably at least 3000 and no greater than 10,000, and more preferably at least 5000 and no greater than 8000. The number average molecular weight of the monomer forming the third repeating unit is measured by gel permeation chromatography with use of polystyrene as a standard material and tetrahydrofuran containing 50 mmol/L of acetic acid as a solvent.

From the viewpoint of impartment of moderate hydrophobicity to the specific polymer, the percentage content of the third repeating unit is preferably at least 5% by mass and no greater than 50% by mass to the mass of the specific polymer, more preferably at least 5% by mass and no greater than 40% by mass, further preferably at least 5% by mass and no greater than 35% by mass, still more preferably at least 10% by mass and no greater than 30% by mass, and particularly preferably at least 12% by mass and no greater than 27% by mass. As a result of impartment of moderate hydrophobicity to the specific polymer, the specific polymer is sufficiently attached to the surface of the pigment to disperse the pigment particles in the aqueous medium. The number of the third repeating unit included in the specific polymer is preferably at least 1 or 2, and more preferably 1. Note that where the specific polymer includes two or more third repeating units, the percentage content of the third repeating unit is a total percentage content of the two or more third repeating units.

The monomer (styrene-based macromer having a polymerizable functional group at one end thereof) forming the third repeating unit may be a commercially available one. Examples of the commercially available one include AS-6, AS-6S, AN-6, AN-6S, HS-6, and HS-6S each produced by Toagosei Co., Ltd.

(Fourth Repeating Unit)

The fourth repeating unit is a repeating unit derived from nonionic acrylic acid ester or nonionic methacrylic acid ester. The nonionic fourth repeating unit helps disperse the pigment particles in the aqueous medium. In addition, as a result of the specific polymer including the fourth repeating unit, images with excellent scratch resistance can be formed with use of the ink.

Examples of the monomer (nonionic (meth)acrylic acid ester) forming the fourth repeating unit include alkylene glycol ester of (meth)acrylic acid, (meth)acrylic acid ester having an aromatic ring group, and alkyl ester of (meth)acrylic acid. Examples of the alkylene glycol ester of (meth)acrylic acid include methoxypolyethylene glycol mono(meth)acrylate, polyethylene glycol mono(meth)acrylate, methoxypolypropylene glycol mono(meth)acrylate, polypropylene glycol mono(meth)acrylate, ethylene glycol-propylene glycol (meth)acrylate, poly(ethylene glycol-propylene glycol) mono(meth)acrylate, and octoxypolyethylene glycol-polypropylene glycol mono(meth)acrylate. Examples of the (meth)acrylic acid ester having an aromatic ring group include benzyl methacrylate and ethoxylated o-phenylphenol acrylate. Examples of the alkyl ester of (meth)acrylic acid include methyl (meth)acrylate, ethyl (meth)acrylate, isopropyl (meth)acrylate, isobutyl (meth)acrylate, t-butyl (meth)acrylate, 2-ethylhexyl (meth)acrylate, straight chain or branched chain octyl (meth)acrylate, straight chain or branched chain decyl (meth)acrylate, straight chain or branched chain dodecyl (meth)acrylate, straight chain or branched chain stearyl (meth)acrylate, and straight chain or branched chain behenyl (meth)acrylate.

Preferably, the fourth repeating unit is represented by formula (4).

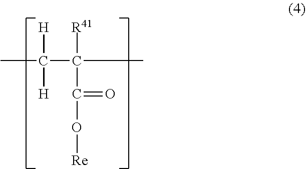

In formula (4), R⁴¹ represents a hydrogen atom or a methyl group. Re represents a benzyl group, an alkyl group with a carbon number of at least 1 and no greater than 22, or a group having a polyoxyalkylene chain. The alkyl group with a carbon number of at least 1 and no greater than 22 that is represented by Re is preferably an alkyl group with a carbon number of at least 1 and no greater than 6, more preferably an alkyl group with a carbon number of at least 1 and no greater than 3, and particularly preferably a methyl group. Re preferably represents a benzyl group, an alkyl group with a carbon number of at least 1 and no greater than 6, or a group having a polyoxyalkylene chain. The group having a polyoxyalkylene chain is a group represented by formula (4A), for example.

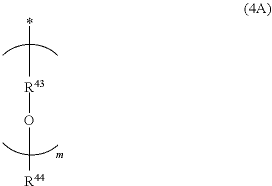

In formula (4A), R⁴³ represents an alkanediyl group with a carbon number of at least 2 and no greater than 18. R⁴⁴ represents a hydrogen atom, a biphenyl group, an alkyl group with a carbon number of at least 1 and no greater than 18, or a phenyl group optionally substituted with an alkyl group with a carbon number of at least 1 and no greater than 8. m represents an average number of moles added. * represents a bond, and specifically represents a bond that bonds to an oxygen atom to which a carbonyl group in formula (4) is bonded.

The alkanediyl group with a carbon number of at least 2 and no greater than 18 that is represented by R⁴³ is preferably an alkanediyl group with a carbon number of at least 2 and no greater than 4. From the viewpoint of optimization of ejection stability of the ink from the recording head, the alkanediyl group with a carbon number of at least 2 and no greater than 4 is preferably an ethylene group. From the viewpoint of optimization of preservation stability of the ink, the alkanediyl group with a carbon number of at least 2 and no greater than 4 is preferably a propylene group or a tetramethylene group.

From the viewpoint of optimization of preservation stability of the ink, m represents preferably the number of at least 1 and no greater than 30, more preferably the number of at least 2 and no greater than 25, and further preferably the number of at least 5 and no greater than 15. m chemical groups R⁴³ may be the same as or different from one another. Where the chemical groups R⁴³ are different from one another, “—R⁴³—O—” may be block-added or randomly added.

From the viewpoint of optimization of preservation stability of the ink, the alkyl group with a carbon number of at least 1 and no greater than 18 that is represented by R⁴⁴ is preferably an alkyl group with a carbon number of at least 1 and no greater than 12, more preferably an alkyl group with a carbon number of at least 1 and no greater than 8, and further preferably a methyl group, an ethyl group, a propyl group, an isopropyl group, a butyl group, a t-butyl group, a hexyl group, an octyl group, or a 2-ethylhexyl group. The phenyl group optionally substituted with an alkyl group with a carbon number of at least 1 and no greater than 8 that is represented by R⁴ is preferably a phenyl group.

Preferably, R⁴ represents a hydrogen atom or a biphenyl group.

Preferable examples of formula (4) include formulas (4-1) to (4-4). m₁ in formula (4-2) and m₂ in formula (4-3) are the same as defined for m in formula (4A). The repeating unit represented by formula (4-1) is a repeating unit derived from benzyl methacrylate. The repeating unit represented by formula (4-2) is a repeating unit derived from polypropylene glycol monomethacrylate. The repeating unit represented by formula (4-3) is a repeating unit derived from ethoxylated o-phenylphenol acrylate. The repeating unit represented by formula (4-4) is a repeating unit derived from methyl methacrylate.

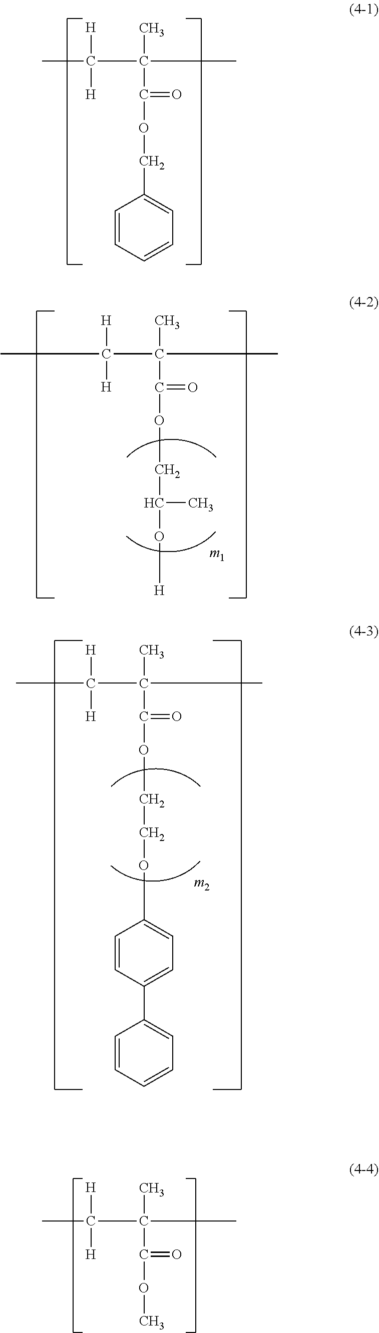

From the viewpoint of helping dispersion of the pigment particles in the aqueous medium and the viewpoint of formation of images with excellent scratch resistance with use of the ink, the percentage content of the fourth repeating unit is preferably at least 1% by mass and no greater than 60% to the mass to the specific polymer, more preferably at least 10% by mass and no greater than 60% by mass, further preferably at least 40% by mass and no greater than 55% by mass, and particularly preferably at least 43% by mass and no greater than 55% by mass. The specific polymer includes at least one and no greater than four fourth repeating units, and more preferably at least one and no greater than three fourth repeating unit. Note that where the specific polymer includes two or more fourth repeating units, the percentage content of the fourth repeating unit is the total percentage content of the two or more fourth repeating units.

(Repeating Unit other than First to Fourth Repeating Units)

The specific polymer may further include a repeating unit (also referred to below as additional repeating unit) other than the first to fourth repeating units. An example of the additional repeating unit is a repeating unit (also referred to below as silicone-based macromer-derived repeating unit) derived from a silicone-based macromer having a polymerizable functional group at one end thereof. Where the specific polymer includes the silicone-based macromer-derived repeating unit, the specific polymer has an organopolysiloxane chain as the side chain, for example. The silicone-based macromer forming the silicone-based macromer-derived repeating unit is represented by formula [CH₂═C(CH₃)—COOC₃H₆—[Si(CH₃)₂—O-]t-Si(CH₃)₃], for example. In the above formula, t represents a number of at least 8 and no greater than 40.

(Others)

From the viewpoint of optimization of preservation stability of the ink and scratch resistance of images formed with use of the ink, a ratio Mm/Ms between a mass Mm of the main chain of the specific polymer and a mass Ms of the side chain thereof is preferably at least 1/1 and no greater than 20/1, more preferably at least 3/2 and no greater than 15/1, and further preferably at least 2/1 and no greater than 10/1. Note that the polymerizable functional group moiety is also taken to be the side chain in calculation of the ratio Mm/Ms.

From the viewpoint of optimization of preservation stability of the ink and scratch resistance of images formed with use of the ink, a ratio M1/M2 between a mass M1 of the first repeating unit and a mass M2 of the second repeating unit is preferably at least 1/20 and no greater than 2.5/1, more preferably at least 1/20 and no greater than 1.5/1, further preferably at least 1/20 and no greater than 1/1, still more preferably at least 1/15 and no greater than 1/1.5, and particularly preferably at least 1/10 and no greater than ½. Note that in a case in which the first repeating unit is neutralized, the mass M1 of the first repeating unit means the mass M1 of the first repeating unit before neutralization in the present specification.

From the viewpoint of optimization of dispersion stability and preservation stability of the ink, a ratio M1/M3 between the mass M1 of the first repeating unit and a mass M3 of the third repeating unit is preferably at least ⅕ and no greater than 3/1, more preferably at least ⅕ and no greater than 2/1, and further preferably at least ¼ and no greater than 2/1.

From the viewpoint of optimization of ejection stability of the ink from the recording head, preservation stability of the ink, and scratch resistance of images formed with use of the ink, a mass M2/M4 between the mass M2 of the second repeating unit and a mass M4 of the fourth repeating unit is preferably at least ⅕ and no greater than 5/1, more preferably at least ⅕ and no greater than 4/1, and further preferably at least ⅕ and no greater than ½.

From the viewpoint of optimization of viscosity of the ink, the amount of the specific polymer dissolved to 100 g of water after complete neutralization of the salt-forming group is preferably no greater than 10 g in an environment at a temperature of 25° C., more preferably no greater than 5 g, and further preferably no greater than 1 g. Note that neutralization of the salt-forming group can be carried out by adding a neutralizer (e.g., sodium hydroxide or acetic acid) according to the type of the salt-forming group.

From the viewpoint of favorable emulsification and dispersion of the pigment particles, the salt-forming group of the specific polymer is preferably neutralized in the ink. The aforementioned neutralizer is used for neutralization of the salt-forming group, for example. The degree of neutralization of the salt-forming group of the specific polymer is preferably at least 10% and no greater than 400%, more preferably at least 20% and no greater than 300%, and further preferably at least 30% and no greater than 250%. Here, the degree of neutralization can be obtained using the following formula (A) where the salt-forming group is anionic. Where the salt-forming group is cationic, the degree of naturalization can be obtained using the following formula (B). The acid value in formula (A) and the amine value in formula (B) are calculated based on the chemical structure of the first repeating unit of the specific polymer. Alternatively, the acid value in formula (A) and the amine value in formula (B) may be measured in a manner that the specific polymer is dissolved in an appropriate solvent (e.g., methyl ethyl ketone) and titrated.

{[mass (unit: g) of neutralizer/equivalent of neutralizer]/[acid value (unit: mgKOH/g) of specific polymer×mass (unit: g) of specific polymer/(56×1000)]}×100 (A)

{[mass (unit: g) of neutralizer/equivalent of neutralizer]/[amine value (unit: mgHCL/g) of specific polymer×mass (unit: g) of specific polymer/(36.5×1000)]}×100 (B)

From the viewpoint of optimization of dispersion stability of the ink and scratch resistance of images formed with use of the ink, the specific polymer has a mass average molecular weight of preferably at least 10,000 and no greater than 1000,000, more preferably at least 20,000 and no greater than 500,000, and further preferably at least 30,000 and no greater than 300,000. The mass average molecular weight of the specific polymer is measured according to the method described in Examples, for example.

From the viewpoint of optimization of preservation stability of the ink, emulsified particles constituted by the specific polymer have a D₅₀ of preferably no greater than 500 nm, more preferably no greater than 300 nm, and further preferably no greater than 200 nm. From the viewpoint of easy production of the ink, the emulsified particles constituted by the specific polymer have a D₅₀ of at least 10 nm, more preferably at least 20 nm, and further preferably at least 50 nm. From the viewpoint of optimization of preservation stability of the ink, the emulsified particles constituted by the specific polymer have a D90 of preferably no greater than 2000 nm, more preferably no greater than 1000 nm, and further preferably no greater than 500 nm. From the viewpoint of easy production of the ink, the emulsified particles constituted by the specific polymer have a D90 of at least 20 nm, more preferably at least 50 nm, and further preferably at least 100 nm.

(Specific Polymer Synthesis Method)

The specific polymer is produced through monomer polymerization by a known polymerization method (e.g., bulk polymerization, solution polymerization, suspension polymerization, or emulsion polymerization). The polymerization method is preferably solution polymerization.

The solvent used in the solution polymerization is preferably a polar organic solvent. Where the polar organic solvent is water miscible, the polar organic solvent may be mixed with water for use. Examples of the polar organic solvent include aliphatic alcohols (specific examples include methanol, ethanol, and propanol) with a carbon number of at least 1 and no greater than 3, ketones (specific examples include acetone, methyl ethyl ketone, and methyl isobutyl ketone), and esters (specific examples include ethyl acetate). The solvent used in solution polymerization is preferably at least one selected from the group consisting of methanol, ethanol, acetone, and methylethylketone, or a mixed solvent of water and at least one selected from the above-mentioned group.

As necessary, a radical polymerization initiator may be used for polymerization of the specific polymer. Examples of the radical polymerization initiator include azo compounds (specific examples include 2,2′-azobisisobutyronitrile and 2,2′-azobis(2,4-dimethylvaleronitrile)), dimethyl-2,2′-azobisbutylate, 2,2′-azobis(2-methylbutyronitrile), and 1,1′-azobis(1-cyclohexane carbonitrile)) and organic peroxides (specific examples include t-butyl peroxyoctoate, di-t-butyl peroxide, and dibenzoyl oxide). The amount of the radical polymerization initiator is preferably at least 0.001 mol and no greater than 5 mol relative to 1 mol of a monomer mixture, and more preferably at least 0.01 mol and no greater than 2 mol.

As necessary, a polymerization chain transfer agent may be used for polymerization of the specific polymer. Example of the polymerization chain transfer agent include mercaptans (specific examples include octyl mercaptan, n-dodecyl mercaptan, t-dodecyl mercaptan, n-tetradecyl mercaptan, 2-mercaptoethanol, 3-mercapto-1,2-propanediol, and mercaptosuccinic acid), thiuram disulfides, hydrocarbons, unsaturated cyclic hydrocarbon compounds, and unsaturated heterocyclic compounds.

The polymerization temperature is preferably at least 30° C. and no greater than 100° C., and more preferably at least 50° C. and no greater than 80° C. The polymerization time is preferably at least 1 hour and no greater than 20 hours. Preferably, polymerization is carried out in an inert gas atmosphere (specific examples include a nitrogen gas atmosphere and an argon gas atmosphere). After termination of the polymerization reaction, the produced specific polymer can be isolated from the reaction solution by a known method (specific examples include reprecipitation and solvent distillation). Alternatively, the produced specific polymer may be purified by a known method (specific examples include reprecipitation, film separation, chromatography, and extraction).

Preferably, the specific polymer has a percentage content of at least 1% by mass and no greater than 10% by mass to the mass of the ink. As a result of the percentage content of the specific polymer being set to at least 1% by mass, images with desired image density can be easily formed with use of the ink. As a result of the percentage content of the specific polymer being set to no greater than 10% by mass, the ink can be further stably ejected from the recording head.

The content ratio of the specific polymer to 100 parts by mass of the pigment is preferably at least 15 parts by mass and no greater than 60 parts by mass, and more preferably at least 25 parts by mass and no greater than 45 parts by mass. As a result of the content ratio of the specific polymer being set to at least 15 parts by mass, images with desired image density can be easily formed with use of the ink. As a result of the content ratio of the specific polymer being set to no greater than 60 parts by mass, the ink can be further stably ejected from the recording head.

<Aqueous Medium>

The aqueous medium includes the water-soluble organic solvent and water. The aqueous medium may function as a solvent or function as a dispersion medium.

As described previously, the water-soluble organic solvent includes the specific solvents (i.e., 1,2-pentanediol and 3-methyl-1,3-butanediol). As also described previously, the specific solvent percentage content is at least 10% by mass and no greater than 30% by mass.

From the viewpoint of optimization of surface tension of the ink, the percentage content of the 1,2-pentanediol is preferably at least 5% by mass and no greater than 15% by mass to the mass of the ink.

From the viewpoint of optimization of viscosity of the ink, the percentage content of the 3-methyl-1,3-butanediol is preferably at least 5% by mass and no greater than 15% by mass to the mass of the ink.

From the viewpoint of optimization of surface tension and viscosity of the ink, a ratio Mb/Mp of a mass Mb of the 3-methyl-1,3-butanediol to a mass Mp of the 1,2-pentanediol is preferably at least 0.6 and no greater than 1.5, more preferably at least 0.6 and no greater than 1.2, further preferably at least 0.8 and no greater than 1.2, and still more preferably at least 1.1 and no greater than 1.2.

The octanol/water partition coefficient Log P (also referred to below simply as “solvent Log P”) of the water-soluble organic solvent is preferably at least −0.50 and no greater than −0.10. As a result of the solvent Log P being set to at least −0.50, images with desired image density can be favorably formed with use of the ink. As a result of the solvent Log P being set to no greater than −0.10 by contrast, images with excellent scratch resistance can be favorably formed with use of the ink.

The solvent Log P can be calculated by the following method. First, a Log Po of each water-soluble organic solvent contained in the ink is calculated using the aforementioned Log P calculating program. With respect to each water-soluble organic solvent, a value (Log Po×Ro) is calculated by multiplying a mole fraction (Ro) of the water-soluble organic solvent in all the water-soluble organic solvents by the Log Po of the water-soluble organic solvent. A sum of all calculated values (Log Po×Ro) for the water-soluble organic solvents is taken to be a solvent Log P. For example, where the water-soluble organic solvent is a mixed solvent of water-soluble organic solvents E to H, the solvent Log P is calculated using a formula “solvent Log P=[(Log P of water-soluble organic solvent E)×(mole fraction R_{E} of water-soluble organic solvent E)]+[(Log P of water-soluble organic solvent F)×(mole fraction R_{F} of water-soluble organic solvent F)]+[(Log P of water-soluble organic solvent G)×(mole fraction R_{G} of water-soluble organic solvent G)]+[(Log P of water-soluble organic solvent H)×(mole fraction R_{H} of water-soluble organic solvent H)]”. The sum of the mole fractions R_{E}, R_{F}, R_{G}, and R_{H} is 100%.

The water-soluble organic solvents may further include a water-soluble organic solvent other than the specific solvents in addition to the specific solvents. Examples of the water-soluble organic solvent other than the specific solvents include glycol compounds other than the specific solvents, glycol ether compounds, lactam compounds, nitrogen-containing compounds, acetate compounds, thiodiglycol, glycerin, and dimethylsulfoxide.

Examples of the glycol compounds other than the specific solvents include ethylene glycol, 1,3-propanediol, propylene glycol, 1,3-butanediol, 2-methyl-1,3-propanediol, 1,5-pentanediol, 1,2-octanediol, 1,8-octanediol, 3-methyl-1,5-pentanediol, diethylene glycol, triethylene glycol, and tetraethylene glycol.

Examples of the glycol ether compounds include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The water-soluble organic solvent other than the specific solvents is preferably at least one selected from the group consisting of glycerin and a glycol compound other than the specific solvents, and more preferably at least 1 (preferably, at least 1 and no greater than 4) selected from the group consisting of glycerin, 1,3-propanediol, propylene glycol, 1,3-butanediol, 2-methyl-1,3-propanediol, 1,5-pentanediol, 3-methyl-1,5-pentanediol, and triethylene glycol monobutyl ether.

From the viewpoint of optimization of ejection stability of the ink from the recording head, the percentage content of the water is preferably at least 30% by mass and no greater than 70% by mass to the mass of the ink. The percentage content of the water-soluble organic solvent is preferably at least 10% by mass and no greater than 45% by mass to the mass of the ink.

<Surfactant>

Preferably, the ink of the present embodiment further contains a surfactant. The surfactant optimizes permeability (wettability) to a recording medium. Examples of the surfactant include an anionic surfactant, a cationic surfactant, and a nonionic surfactant. The surfactant is preferably a nonionic surfactant.

Example of the nonionic surfactant include polyoxyethylene dodecyl ether, polyoxyethylene hexadecyl ether, polyoxyethylene nonylphenyl ether, polyoxyethylene solbitan monooleate ether, monodecanoyl sucrose, and an ethylene oxide adduct of acetylene glycol. The nonionic surfactant is preferably an ethylene oxide adduct of acetylene glycol.

Where the ink contains a surfactant, the percentage content of the surfactant is preferably at least 0.05% by mass and no greater than 3.00% by mass to the mass of the ink, and more preferably at least 0.2% by mass and no greater than 1.0% by mass.

<Other Components>

The ink of the present embodiment may further contain a known additive (e.g., any of a solution stabilizer, an anti-drying agent, an antioxidant, a viscosity modifier, a pH modifier, and an anti-mold agents) as necessary.

<Ink Production Method>

The ink of the present embodiment can be produced by uniformly mixing a pigment dispersion containing the pigment and the specific polymer, the water-soluble organic solvent, water, and a component (e.g., a surfactant) added as necessary using a stirrer. In production of the ink of the present embodiment, foreign matter and coarse particles may be removed using a filter (e.g., a filter with a pore size of no greater than 5 μm) after uniform mixing of the components.

The pigment dispersion is a dispersion containing the pigment and the specific polymer. The dispersion medium of the pigment dispersion is preferably water. From the viewpoint of promotion of emulsification of the specific polymer by neutralization of the salt-forming group, a neutralizer (e.g., sodium hydroxide or acetic acid) according to the type of the salt-forming group may be added to the dispersion medium.

The pigment has a percentage content of preferably at least 5% by mass and no greater than 25% by mass to the mass of the pigment dispersion, and more preferably at least 10% by mass and no greater than 20% by mass. The specific polymer has a percentage content of preferably at least 2% by mass and no greater than 10% by mass to the mass of the pigment dispersion, and more preferably at least 4% by mass and no greater than 8% by mass.

The pigment dispersion can be prepared by wet dispersion of the pigment, the specific polymer, a dispersion medium (e.g., water), and a component (e.g., a surfactant) added as necessary using a wet-type medium disperser. For example, a small-diameter beads (e.g., beads with a D₅₀ of at least 0.1 mm and no greater than 1.0 mm) may be used as a medium in the wet-type medium disperser. No particular limitations are placed on the material of the beads, and the material of the meads is preferably a hard material (e.g., glass or zirconia).

Where the pigment dispersion is added in production of the ink of the present embodiment, the ratio of the pigment dispersion to all the raw materials of the ink is at least 30% by mass and no greater than 70% by mass, for example.

### EXAMPLES

The following describes examples of the present disclosure. However, the present disclosure is no way limited to the following examples. In the following, “part by mass” may be referred to as “part”.

<Polymer Synthesis>

Polymers (P-A) to (P-J) were synthesized. The compositions of these polymers are shown in Tables 1 and 2. In Tables 1 and 2, the number indicated left in the parentheses below the amount of a corresponding monomer indicates the amount of a later-described mixed solution (I) while the number indicated right therein indicates the amount of a later-described mixed solution (II).

TABLE 1

| Polymer | | | P-A | P-B | P-C | P-D | P-E |
|---|---|---|---|---|---|---|---|
| Composition | First unit | Methacrylic acid | — | — | 6 | 11 | 5 |
| [part] | | | | | (2/4) | (3/8) | (2/3) |
| | | Acrylic acid | 30 | 10 | — | — | — |
| | | | (2/28) | (3/7) | | | |
| | | Maleic acid | — | 10 | — | 5 | — |
| | | | | (3/7) | | (2/3) | |
| | | Itaconic acid | — | — | 5 | — | 6 |
| | | | | | (2/3) | | (3/3) |
| | Third unit | Styrene macromer | 12 | 17 | 20 | 24 | 23 |
| | | | (1/11) | (7/10) | (6/14) | (6/18) | (7/16) |
| | Second unit | Styrene | 12 | 13 | 14 | 17 | 14 |
| | | | (5/7) | (4/9) | (7/7) | (7/10) | (6/8) |
| | Fourth unit | Benzyl methacrylate | 22 | 20 | 20 | 10 | 18 |
| | | | (4/18) | (5/15) | (5/15) | (3/7) | (5/13) |
| | | Polypropylene glycol | 24 | 21 | 21 | — | — |
| | | monomethacrylate | (3/21) | (4/17) | (4/17) | | |
| | | Ethoxylated o-phenyl | — | — | — | 28 | 31 |
| | | phenol acrylate | | | | (6/22) | (8/23) |
| | | Methyl methoacrylate | — | 9 | 14 | 5 | 3 |
| | | | | (2/7) | (4/10) | (2/3) | (1/2) |

| | | | | | |
|---|---|---|---|---|---|
| Total amount | 100 | 100 | 100 | 100 | 100 |

| | | | | | |
|---|---|---|---|---|---|
| LogP (polymer) | 2.0 | 2.5 | 3.1 | 3.4 | 3.8 |
| Mw | 15000 | 15000 | 15000 | 15000 | 15000 |

TABLE 2

| Polymer | | | P-F | P-G | P-H | P-I | P-J |
|---|---|---|---|---|---|---|---|
| Composition | First unit | Methacrylic acid | 14 | 21 | 10 | 5 | 17 |
| [part] | | | (3/11) | (4/17) | (3/7) | (2/3) | (6/11) |
| | | Acrylic acid | — | 17 | — | — | 30 |
| | | | | (7/10) | | | (7/23) |
| | | Maleic acid | — | — | — | — | — |
| | | Itaconic acid | — | — | — | 6 | — |
| | | | | | | (2/4) | |
| | Third unit | Styrene macromer | 27 | 12 | 27 | — | 23 |
| | | | (10/17) | (5/7) | (12/15) | | (10/13) |
| | Second unit | Styrene | 15 | 4 | 19 | — | 30 |
| | | | (5/10) | (2/2) | (8/11) | | (9/21) |
| | Fourth unit | Benzyl methacrylate | 16 | 22 | 16 | 25 | — |
| | | | (4/12) | (8/14) | (8/8) | (10/15) | |
| | | Polypropylene glycol | 28 | 24 | 28 | 30 | — |
| | | monomethacrylate | (10/18) | (10/14) | (10/18) | (10/20) | |
| | | Ethoxylated o-phenyl | — | — | — | 31 | — |
| | | phenol acrylate | | | | (12/19) | |
| | | Methyl methoacrylate | — | — | — | 3 | — |
| | | | | | | (1/2) | |

| | | | | | |
|---|---|---|---|---|---|
| Total amount | 100 | 100 | 100 | 100 | 100 |

| | | | | | |
|---|---|---|---|---|---|
| LogP (polymer) | 4.0 | 1.9 | 4.2 | 2.7 | 2.0 |
| Mw | 20000 | 15000 | 20000 | 15000 | 15000 |

The terms in Tables 1 and 2 mean as follows.
First to fourth units: Monomers for forming first to fourth repeating units
Styrene macromer: Styrene macromer (“AS-6S”, product of Toagosei Co., Ltd.)
Log P (polymer): Log P of polymer
Mw: Mass average molecular weight
—: No containment of corresponding component

The total amount of the monomers used for the synthesis of each polymer is 100 parts. Furthermore, since the polymer synthesis is carried out through addition polymerization, the mass of a monomer and the mass of a repeating unit formed from the monomer are the same as each other. From the above, the amount (unit: part) of each monomer indicated in the column titled “Composition” in Tables 1 and 2 corresponds to the percentage content (unit: % by mass) of a corresponding repeating unit derived from the monomer to the mass of a corresponding polymer. For example, the mass (unit: part) indicated in the column titled “Styrene” corresponds to the percentage content (unit: % by mass) of the repeating unit derived from styrene to the mass of a corresponding polymer. For example, the sum (unit: part) of the masses indicated in the columns titled “Methacrylic acid”, “Acrylic acid”, “Maleic acid”, and “Itaconic acid” corresponds to the first unit percentage (unit: % by mass).

(Synthesis of Polymer (P-A))

A mixed solution (I) was obtained by adding into a reaction vessel and mixing parts of methyl ethyl ketone, 0.01 parts of 2-mercaptoethanol being a polymerization chain transfer agent, 3 parts of polypropylene glycol monomethacrylate (product of Sigma-Aldrich Japan, compound constituted by methacrylic acid and 9 mol of propylene glycol, Mw: 608, average number n of moles added of propylene glycol: 9, terminal group: —OH group), 4 parts of benzyl methacrylate, 2 parts of acrylic acid, 5 parts of styrene, and 1 part of styrene macromer (“AS-6S”, product of Toagosei Co., Ltd., styrene macromer constituted by glycidyl methacrylate, 3-mercaptopropionic acid, and 55 mol of styrene, Mw: 6000). The air in the reaction vessel was replaced with a nitrogen gas. While, 21 parts of the aforementioned polypropylene glycol monomethacrylate, 18 parts of benzyl methacylate, 28 parts of acrylic acid, 7 parts of styrene, and 11 parts of the aforementioned styrene macromer were put onto a dripping funnel. A mixed solution (II) was obtained by further putting onto the dripping funnel and mixing 0.09 parts of the aforementioned polymerization chain transfer agent, 70 parts of methyl ethyl ketone, and 1.2 parts of 2,2′-azobis(2,4-dimethylvaleronitrile). The air in the dripping funnel was replaced with a nitrogen gas. In the nitrogen atmosphere, the temperature of the mixed solution (I) in the reaction vessel was increased up to 75° C. under stirring and the mixed solution (II) in the dripping funnel was gradually dripped over 3 hours. The liquid in the reaction vessel was kept at 75° C. for 2 hours after termination of the dripping. Next, a solution (III) was added into the reaction vessel. The solution (III) was a solution obtained by dissolving 0.3 parts of 2,2′-azobis(2,4-dimethylvaleronitrile) in 5 parts of methyl ethyl ketone. Next, the liquid in the reaction vessel was kept at 75° C. for 2 hours and further kept at 85° C. for 2 hours. In the manner described above, the liquid in the reaction vessel was matured to obtain a polymer solution. The polymer solution was dried at 105° C. for 2 hours under reduced pressure to remove the solvent. In the manner described above, a polymer (P-A) was obtained.

(Synthesis of Polymer (P-B) to (P-J))

Polymers (P-B) to (P-J) were synthesized according to the same method as that for synthesizing the polymer (P-A) in all aspects other than use of the monomers indicated in Tables 1 and 2 in the amounts indicated in these tables.

(Calculation of Log P of Polymer)

Each Log P of the polymers (P-A) to (P-J) was calculated according to the method described in the embodiment. In the calculation, the molecular weights and the Log P of each monomer indicated in Table 3 were used. The Log P of each monomer in Table 3 was obtained using the Log P calculating program described in the embodiment. Tables 1 and 2 show the calculated Log P of each polymer.

TABLE 3

| | | Molecular | |
|---|---|---|---|
| Monomer | | weight | LogP |
| First unit | Methacrylic acid | 86 | 0.99 |
| | Acrylic acid | 72 | 0.44 |
| | Maleic acid | 116 | −0.48 |
| | Itaconic acid | 130 | −0.31 |
| Third unit | Styrene macromer | 6000 | 160.80 |
| Second unit | Styrene | 104 | 2.98 |
| Fourth unit | Benzyl methacrylate | 176 | 2.98 |
| | Polypropylene glycol | 608 | 4.32 |
| | monomethacrylate | | |
| | ethoxylated o-phenylphenol acrylate | 268 | 3.98 |
| | Methyl methacrylate | 100 | 1.38 |

As an example, a method for calculating a Log P of the polymer (P-A) is described below. According to “Log P of polymer (P-A)=[Log P of acrylic acid×mole fraction of acrylic acid]+[Log P of styrene macromer×mole fraction of styrene macromer]+[Log P of styrene×mole fraction of styrene]+[Log P of benzyl methacrylate×mole fraction of benzyl methacrylate]+[Log P of polypropylene glycol monomethacrylate×mole fraction of polypropylene glycol monomethacrylate]=[0.44×( 30/72)/( 30/72+ 12/6000+ 12/104+ 22/176+ 24/608)]+[160.80×( 12/6000)/( 30/72+ 12/6000+ 12/104+ 22/176+ 24/608)]+[2.98×( 12/104)/( 30/72+ 12/6000+ 12/104+ 22/176+ 24/608)]+[2.98×( 22/176)/( 30/72+ 12/6000+ 12/104+ 22/176+ 24/608)]+[4.32×( 24/608)/( 30/72+ 12/6000+ 12/104+ 22/176+ 24/608)]=2.0, the Log P of the polymer (P-A) was calculated to be 2.0

(Measurement of Mass Average Molecular Weight of Polymer)

The mass average molecular weight (Mw) of each of the polymers (P-A) to (P-J) was measure under the following conditions using a gel permeation chromatography (“LC-9A”, product of Shimadzu Corporation). The gel permeation chromatography was provided with a system controller (“SIL-6B”, product of Shimadzu Corporation), a detector (“RID-6A”, product of Shimadzu Corporation), and data processing software (“Sic480II DATA STATION”, product of SYSTEM INSTRUMENTS Co., Ltd.). Tables 1 and 2 show the measured mass average molecular weight of each polymer.

[Conditions for Measuring Mass Average Molecular Weight]
Colum: GL-R400 (guard column), GL-R440, GL-R450, and GL-R400M each produced by Showa Denko Materials Co., Ltd.
Number of columns: 4
Eluent: Special grade tetrahydrofuran
Flow rate: 2 mL/min.
Sample injection amount: 1 μL
Measurement temperature: 40° C.
Calibration curve: Calibration curve plotted using n-propyl benzene and F-40, F-20, F-4, F-1, A-5000, A-2500, and A-1000 each being TSKgel standard polystyrene produced by Tosoh Corporation

<Preparation of Pigment Dispersion (D-1)>

(Polymer Dispersion Preparation)

After 7.5 parts of a 5-mol/L sodium hydroxide solution, 5.0 parts of ammonia water at a concentration of 25% by mass, and 217.5 parts of ion exchange water were added into a reaction vessel, the contents of the reaction vessel were mixed. Separately, 30.0 parts of the polymer (P-A) obtained as described above, 40.0 parts of methyl ethyl ketone, and 30.0 parts of acetone were mixed to obtain a polymer solution. The polymer solution was put onto a dropping funnel and dripped into the reaction vessel over 30 minutes. The resultant liquid in the reaction vessel was stirred for 30 minutes to obtain an emulsified composition. The emulsified composition was heated at 60° C. under reduced pressure for removing an organic solvent, ammonia, and a portion of water from the emulsified composition to obtain a concentrated emulsified composition. The concentrated emulsified composition was filtered using a filter (product of Nihon Pall Ltd.) with an average pore size of 5 m to remove coarse particles from the concentrated emulsified composition. In the manner described above, a polymer dispersion in which emulsified particles of the polymer (P-A) have been dispersed was obtained. The polymer dispersion had a solid content of 20% by mass. The emulsified particles of the polymer (P-A) in the polymer dispersion had a D₅₀ of 95 nm and a D₉₀ of 190 nm.

(Measurement of D₅₀ and D₉₀)

The D₅₀ and the D₉₀ of the emulsified particles of the polymer (P-A) were measured using a dynamic light scattering type particle size distribution analyzer (“ZETASIZER NANO ZS”, product of Malvern Instruments Ltd.). The measurement was carried out in an environment at a temperature of 25° C. under conditions of an angle between the incident light and the detector of 173 degrees, a cumulative number of times of 10, and a refractive index of water input as a refractive index of a dispersion solvent of 1.333.

(Pigment Dispersion Preparation)

After 450 parts of carbon black (“: 2600”, product of Mitsubishi Chemical Corporation), 1350 parts of the polymer dispersion obtained as described above, and 1200 parts of ion exchange water were mixed, the resultant mixture was dispersed for 9 hours using a mill (“DYNO (registered Japanese trademark) Mill, product of Willy A. Bachofen AG). In the dispersion process, zirconia beads with a particle diameter of 0.2 mm were used as a medium. The liquid temperature in the dispersion process was controlled to be within a range between 30° C. and 40° C. In the manner described above, a pigment dispersion (D-1) with a pigment concentration of 15% by mass was obtained. The pigment particles included in the pigment dispersion (D-1) had a D₅₀ of 90 nm.

<Preparation of Pigment Dispersions (D-2) to (D-10)>

A pigment dispersion (D-2) was prepared according to the same method as that for preparing the pigment dispersion (D-1) in all aspects other than change of the polymer (P-A) to the polymer (P-B). A pigment dispersion (D-3) was prepared according to the same method as that for preparing the pigment dispersion (D-1) in all aspects other than change of the polymer (P-A) to the polymer (P-C). A pigment dispersion (D-4) was prepared according to the same method as that for preparing the pigment dispersion (D-1) in all aspects other than change of the polymer (P-A) to the polymer (P-D). A pigment dispersion (D-5) was prepared according to the same method as that for preparing the pigment dispersion (D-1) in all aspects other than change of the polymer (P-A) to the polymer (P-E). A pigment dispersion (D-6) was prepared according to the same method as that for preparing the pigment dispersion (D-1) in all aspects other than change of the polymer (P-A) to the polymer (P-F). A pigment dispersion (D-7) was prepared according to the same method as that for preparing the pigment dispersion (D-1) in all aspects other than change of the polymer (P-A) to the polymer (P-G). A pigment dispersion (D-8) was prepared according to the same method as that for preparing the pigment dispersion (D-1) in all aspects other than change of the polymer (P-A) to the polymer (P-H). A pigment dispersion (D-9) was prepared according to the same method as that for preparing the pigment dispersion (D-1) in all aspects other than change of the polymer (P-A) to the polymer (P-I). A pigment dispersion (D-10) was prepared according to the same method as that for preparing the pigment dispersion (D-1) in all aspects other than change of the polymer (P-A) to the polymer (P-J).

<Ink Preparation>

Inks (A-1) to (A-10) of Examples and inks (B-1) to (B-17) of Comparative Examples were prepared. The compositions of these inks are shown in Tables 4 to 6.

TABLE 4

| Example | | | 1 | 2 | 3 | 4 | 5 | 6 | 7 | 8 | 9 | 10 |
|---|---|---|---|---|---|---|---|---|---|---|---|---|
| Ink | | | A-1 | A-2 | A-3 | A-4 | A-5 | A-6 | A-7 | A-8 | A-9 | A-10 |
| Compo- | Pigment | Type | D-1 | D-1 | D-6 | D-6 | D-2 | D-3 | D-4 | D-5 | D-1 | D-1 |
| sition | dispersion | Polymer | P-A | P-A | P-F | P-F | P-B | P-C | P-D | P-E | P-A | P-A |
| [part] | | Amount | 46.67 | 46.67 | 46.67 | 46.67 | 46.67 | 46.67 | 46.67 | 46.67 | 46.67 | 46.67 |
| | | [part] | | | | | | | | | | |

| | | | | | | | | | | |
|---|---|---|---|---|---|---|---|---|---|---|
| Surfynol 440 | 0.40 | 0.40 | 0.40 | 0.40 | 0.40 | 0.40 | 0.40 | 0.40 | 0.40 | 0.40 |
| Water | Rest | Rest | Rest | Rest | Rest | Rest | Rest | Rest | Rest | Rest |
| 3-Methyl-1,3- | 10.00 | 10.00 | 10.00 | 10.00 | 14.00 | 5.00 | 5.00 | 5.00 | 5.00 | 15.00 |
| butanediol | | | | | | | | | | |
| 1,2-Pentanediol | 17.00 | 10.00 | 17.00 | 10.00 | 12.00 | 6.00 | 6.00 | 6.00 | 5.00 | 15.00 |
| Propylene glycol | — | — | — | — | 5.00 | 5.00 | 5.00 | — | 2.00 | — |
| Triethylene glycol | — | — | — | — | — | — | — | — | — | — |
| monobutyl ether | | | | | | | | | | |
| 3-Methyl-1,5- | — | — | — | — | — | — | — | — | — | — |
| pentanediol | | | | | | | | | | |
| 1,5-Pentanediol | — | — | — | — | — | — | 3.00 | — | — | 13.00 |
| 1,3-Butanediol | 10.00 | — | 10.00 | — | 5.00 | 10.00 | 5.00 | 10.00 | 10.00 | — |
| 2-Methyl-1,3- | — | — | — | — | — | — | — | 3.00 | — | — |
| propanediol | | | | | | | | | | |
| 1,3-Propanediol | — | — | — | — | — | — | — | — | — | — |
| Glycerin | — | 6.50 | — | 6.50 | — | — | 2.00 | 2.00 | 4.00 | — |
| Total amount | 100.00 | 100.00 | 100.00 | 100.00 | 100.00 | 100.00 | 100.00 | 100.00 | 100.00 | 100.00 |

| | | | | | | | | | | |
|---|---|---|---|---|---|---|---|---|---|---|
| LogP (Solvent) | −0.10 | −0.50 | −0.10 | −0.50 | −0.23 | −0.34 | −0.45 | −0.33 | −0.49 | −0.08 |
| Specific solvent | 27.00 | 20.00 | 27.00 | 20.00 | 26.00 | 11.00 | 11.00 | 11.00 | 10.00 | 30.00 |
| percentage content | | | | | | | | | | |
| [% by mass] | | | | | | | | | | |
| Mb/Mp | 0.6 | 1.0 | 0.6 | 1.0 | 1.2 | 0.8 | 0.8 | 0.8 | 1.0 | 1.0 |

TABLE 5

| Comparative Example | | | 1 | 2 | 3 | 4 | 5 | 6 | 7 | 8 | 9 |
|---|---|---|---|---|---|---|---|---|---|---|---|
| Ink | | | B-1 | B-2 | B-3 | B-4 | B-5 | B-6 | B-7 | B-8 | B-9 |
| Compo- | Pigment | Type | D-1 | D-1 | D-6 | D-7 | D-7 | D-8 | D-8 | D-1 | D-6 |
| sition | dispersion | Polymer | P-A | P-A | P-F | P-G | P-G | P-H | P-H | P-A | P-F |
| [part] | | Amount | 46.67 | 46.67 | 46.67 | 46.67 | 46.67 | 46.67 | 46.67 | 46.67 | 46.67 |
| | | [part] | | | | | | | | | |

| | | | | | | | | | |
|---|---|---|---|---|---|---|---|---|---|
| Surfynol 440 | 0.40 | 0.40 | 0.40 | 0.40 | 0.40 | 0.40 | 0.40 | 0.40 | 0.40 |
| Water | Rest | Rest | Rest | Rest | Rest | Rest | Rest | Rest | Rest |
| 3-Methyl-1,3- | 25.00 | 18.00 | 18.00 | 10.00 | 10.00 | 10.00 | 10.00 | — | — |
| butanediol | | | | | | | | | |
| 1,2-Pentanediol | 15.00 | 19.00 | 18.00 | 17.00 | 10.00 | 17.00 | 10.00 | — | — |
| Propylene glycol | — | — | — | — | — | — | — | 10.00 | — |
| Triethylene glycol | — | — | — | — | — | — | — | — | 10.00 |
| monobutyl ether | | | | | | | | | |
| 3-Methyl-1,5- | — | — | — | — | — | — | — | 10.00 | — |
| pentanediol | | | | | | | | | |
| 1,5-Pentanediol | — | — | — | — | — | — | — | 5.00 | 10.00 |
| 1,3-Butanediol | — | — | — | 10.00 | — | 10.00 | — | — | — |
| 2-Methyl-1,3- | — | — | — | — | — | — | — | — | — |
| propanediol | | | | | | | | | |
| 1,3-Propanediol | — | — | — | — | — | — | — | — | 14.00 |
| Glycerin | — | 15.00 | 15.00 | — | 6.50 | — | 6.50 | — | — |
| Total amount | 100.00 | 100.00 | 100.00 | 100.00 | 100.00 | 100.00 | 100.00 | 100.00 | 100.00 |

| | | | | | | | | | |
|---|---|---|---|---|---|---|---|---|---|
| LogP (Solvent) | −0.05 | −0.58 | −0.59 | −0.10 | −0.50 | −0.10 | −0.50 | −0.38 | −0.35 |
| Specific solvent | 40.00 | 37.00 | 36.00 | 27.00 | 20.00 | 27.00 | 20.00 | — | — |
| percentage content | | | | | | | | | |
| [% by mass] | | | | | | | | | |
| Mb/Mp | 1.7 | 0.9 | 1.0 | 0.6 | 1.0 | 0.6 | 1.0 | — | — |

TABLE 6

| Comparative Example | | | 10 | 11 | 12 | 13 | 14 | 15 | 16 | 17 |
|---|---|---|---|---|---|---|---|---|---|---|
| Ink | | | B-10 | B-11 | B-12 | B-13 | B-14 | B-15 | B-16 | B-17 |
| Compo- | Pigment | Type | D-7 | D-7 | D-8 | D-8 | D-9 | D-9 | D-10 | D-10 |
| sition | dispersion | Polymer | P-G | P-G | P-H | P-H | P-I | P-I | P-J | P-J |
| [part] | | Amount | 46.67 | 46.67 | 46.67 | 46.67 | 46.67 | 46.67 | 46.67 | 46.67 |
| | | [part] | | | | | | | | |

| | | | | | | | | |
|---|---|---|---|---|---|---|---|---|
| Surfynol 440 | 0.40 | 0.40 | 0.40 | 0.40 | 0.40 | 0.40 | 0.40 | 0.40 |
| Water | Rest | Rest | Rest | Rest | Rest | Rest | Rest | Rest |
| 3-Methyl-1,3- | 10.00 | 10.00 | 10.00 | 10.00 | 10.00 | 10.00 | 10.00 | 10.00 |
| butanediol | | | | | | | | |
| 1,2-Pentanediol | 17.00 | 10.00 | 17.00 | 10.00 | 17.00 | 10.00 | 17.00 | 10.00 |
| Propylene glycol | — | — | — | — | — | — | — | — |
| Triethylene glycol | — | — | — | — | — | — | — | — |
| monobutyl ether | | | | | | | | |
| 3-Methyl-1,5- | — | — | — | — | — | — | — | — |
| pentanediol | | | | | | | | |
| 1,5-Pentanediol | — | — | — | — | — | — | — | — |
| 1,3-Butanediol | 10.00 | — | 10.00 | — | 10.00 | — | 10.00 | — |
| 2-Methyl-1,3- | — | — | — | — | — | — | — | — |
| propanediol | | | | | | | | |
| 1,3-Propanediol | — | — | — | — | — | — | — | — |
| Glycerin | — | 6.50 | — | 6.50 | — | 6.50 | — | 6.50 |
| Total amount | 100.00 | 100.00 | 100.00 | 100.00 | 100.00 | 100.00 | 100.00 | 100.00 |

| | | | | | | | | |
|---|---|---|---|---|---|---|---|---|
| LogP (Solvent) | −0.10 | −0.46 | −0.10 | −0.46 | −0.10 | −0.46 | −0.10 | −0.46 |
| Specific solvent | 27.00 | 20.00 | 27.00 | 20.00 | 27.00 | 20.00 | 27.00 | 20.00 |
| percentage content | | | | | | | | |
| [% by mass] | | | | | | | | |
| Mb/Mp | 0.6 | 1.0 | 0.6 | 1.0 | 0.6 | 1.0 | 0.6 | 1.0 |

The terms in Tables 4 to 6 mean as follows.
Polymer in column “Pigment dispersion”: Type of polymer contained in pigment dispersion
Amount in column “Pigment Dispersion”: Mass of pigment dispersion
Surfynol 440: Surfactant (“SURFYNOL (registered Japanese trademark) 440”, product of Nissin Chemical Industry Co., Ltd., nonionic surfactant, component: ethylene oxide adduct of acetylene glycol)
Water: Ion exchange water
Log P (solvent): Solvent Log P
Specific solvent percentage content: Total percentage content of 1,2-pentanediol and 3-methyl-1,3-butanediol to mass of ink. Specific solvent percentage content is calculated using a formula “specific solvent percentage content=100×[(mass of 1.2-pentanediol)+(mass of 3-methyl-1,3-butanediol)]/mass of ink”.
Mb/Mp: Ratio Mb/Mp of mass Mb of 3-methyl-1,3-butanediol to mass Mp of 1,2-pentanediol
—: No containment of corresponding component
Rest: Amount that makes total amount of components contained in ink 100.00 parts

(Preparation of Ink (A-1))

The components shown in the column titled (A-1) for Ink in Table 4 were mixed to obtain a liquid mixture. In detail, the liquid mixture was obtained by mixing 46.67 parts of the pigment dispersion (D-1), 10.00 parts of 3-methyl-1,3-butanediol, 17.00 parts of 1,2-pentanediol, 10.00 parts of 1,3-butanediol, 0.40 parts of a surfactant (“SURFYNOL (registered Japanese trademark) 440”, product of Nissin Chemical Industry Co., Ltd., nonionic surfactant, component: ethylene oxide adduct of acetylene glycol), and the rest (15.93 parts) of ion exchange water. The resultant liquid mixture was filtered using a needleless syringe (product of Terumo Corporation) equipped with a filter (filter of PTFE membrane produced by Merck Millipore, average pore size: 5 μm, outer diameter: 2.5 cm) to remove coarse particles. In the manner described above, an ink (A-1) was obtained. The ink (A-1) had a pigment concentration of 7% by mass.

(Preparation of inks (A-2) to (A-10) and (B-1) to (B-17))

Inks (A-2) to (A-10) and (B-1) to (B-17) were prepared according to the same method as that for preparing the ink (A-1) in all aspects other than that the components shown in the column titled “Ink” in tables 4 to 6 were mixed.

(Solvent Log P Calculation)

According to the method described in the embodiment, a solvent Log P of each water-soluble organic solvent contained the inks (A-1) to (A-10) and (B-1) to (B-17) was calculated. In the calculation, the molecular weight and the Log P of each water-soluble organic solvent shown in Table 7 were used. The Log P of each water-soluble organic solvent in Table 7 was obtained using the Log P calculating program described in the embodiment. Tables 4 to 6 show the calculated solvent Log P of each ink.

TABLE 7

| Water-soluble organic solvent | Molecular weight | LogP |
|---|---|---|
| 3-Methyl-1,3-butanediol | 104 | −0.08 |
| 1,2-Pentanediol | 104 | 0.01 |
| Propylene glycol | 76 | −0.92 |
| Triethylene glycol monobutyl ether | 209 | 0.44 |
| 3-Methyl-1,5-pentanediol | 118 | 0.35 |
| 1,5-Pentanediol | 104 | −0.19 |
| 1,3-Butanediol | 90 | −0.29 |
| 2-Methyl-1,3-propanediol | 90 | −0.51 |
| 1,3-Propanediol | 76 | −1.04 |
| Glycerin | 92 | −1.76 |

As an example, a method for calculating a solvent Log P of the ink (A-1) is indicated below. According to “solvent Log P of ink (A-1)=[Log P of 3-methyl-1,3-butanediol×mole fraction of 3-methyl-1,3-butanediol]+[Log P of 1,2-pentanediol×mole fraction of 1,2-pentanediol]+[Log P of 1,3-butanediol×mole fraction of 1,3-butanediol]=[−0.08×(10.00/104)/(10.00/104+17.00/104+10.00/90)]+[0.01×(17.00/104)/(10.00/104+17.00/104+10.00/90)]+[−0.29×(10.00/90)/(10.00/104+17.00/104+10.00/90)]=−0.10, the solvent Log P of the ink (A-1) was calculated to be −0.10.

<Evaluation>

With respect to each of the inks (A-1) to (A-10) and (B-1) to (B-17), image density and scratch resistance of formed images and ejection stability (specifically, continuous ejection stability and intermittent ejection stability) of the ink from a recording head were evaluated by the following methods. Note that each evaluation was carried out in an environment at a temperature of 25° C. and a relative humidity of 50%. Tables 8 to 10 show evaluation values and evaluation results of the evaluations.

(Evaluation Apparatus)

In each evaluation, an inkjet recording apparatus (prototype produced by KYOCERA Document Solutions Japan Inc.) including a line recording head (of piezoelectric type) was used as an evaluation apparatus. The ink (specifically, any of the inks (A-1) to (A-10) and (B-1) to (B-17)) being an evaluation target was loaded in the black-ink tank of the evaluation apparatus. The amount of ink ejected per pixel was set to 11.5 pL. In each evaluation, A4-size plain paper (“CC90”, product of Mondi) was used as a recording medium.

(Image Density)

Using the evaluation apparatus, a solid image (size: 10 cm×10 cm) was formed on the recording medium. The image density (ID) of the formed solid image was measured using a reflectance densitometer (“eXact”, product of X-Rite Inc.). In detail, image densities of randomly selected 10 locations in the solid image were measured using the reflectance densitometer and the arithmetic mean value of the 10 image densities was taken to be an evaluation value for image density. Image density was evaluated according to the following criteria.

Good (A): evaluation value of at least 1.3

Poor (B): evaluation value of less than 1.3

(Scratch Resistance)

Using the evaluation apparatus, a solid image (size: 10 cm×10 cm) was formed on the recording medium. Next, an unused recording medium (evaluation paper) was placed on the recording medium with the solid image formed thereon. Next, a 1-kg rectangular-shaped weight was placed on the evaluation paper. In doing so, the weight was placed so that the center of gravity of the weight was located at the center of the solid image. Next, the evaluation paper was moved back and forth 10 times in a specific direction with the weight placed thereon so that only the dead weight of the weight was applied to rub the solid image with the evaluation paper. The image density of a smeared image transferred to the evaluation paper from the solid image was measured using the reflectance densitometer (“eXact”, product of X-Rite Inc.). In detail, image densities of randomly selected 10 locations in the smeared image were measured using the reflectance densitometer and the arithmetic mean value of the 10 image densities was taken to be an evaluation value for scratch resistance. Scratch resistance was evaluated according to the following criteria.

Good (A): evaluation value of less than 0.008

Poor (B): evaluation value of at least 0.008

(Continuous Ejection Stability)

Using the evaluation apparatus, formation of a solid image on the entirety of the recording medium was continued for 30 minutes. In doing so, the drive frequency of the recording head was set to 20 kHz. Next, a nozzle check pattern was formed on the recording medium using the evaluation apparatus and the presence or absence of nozzle missing (nozzle that has caused an ejection failure) was checked. Continuous ejection stability was evaluated according to the following criteria. Note that the total number of nozzles was 2000.

Good (A): no nozzle missing occurred in all nozzles

Poor (B): nozzle missing occurred in at least some nozzle

(Intermittent Ejection Stability)

After the evaluation of continuous ejection stability, purging and wiping of the nozzles of the evaluation apparatus were performed and the evaluation apparatus was left to stand at 25° C. for 6 hours with the nozzles capped. The nozzle check pattern was formed on the recording medium using the evaluation apparatus left to stand, and the presence or absence of nozzle missing (nozzle that has caused an ejection failure) was checked. Intermittent ejection stability was evaluated according to the following criteria.

Good (A): no nozzle missing occurred in all nozzles

Poor (B): nozzle missing occurred in at least some nozzle

TABLE 8

| Example | | 1 | 2 | 3 | 4 | 5 | 6 | 7 | 8 | 9 | 10 |
|---|---|---|---|---|---|---|---|---|---|---|---|
| Ink | | A-1 | A-2 | A-3 | A-4 | A-5 | A-6 | A-7 | A-8 | A-9 | A-10 |
| Image | Evaluation value | 1.3 | 1.3 | 1.3 | 1.3 | 1.3 | 1.3 | 1.3 | 1.3 | 1.3 | 1.3 |
| density | Evaluation | A | A | A | A | A | A | A | A | A | A |
| Scratch | Evaluation value | 0.006 | 0.006 | 0.007 | 0.007 | 0.006 | 0.007 | 0.007 | 0.007 | 0.006 | 0.007 |
| resistance | Evaluation | A | A | A | A | A | A | A | A | A | A |

| | | | | | | | | | | |
|---|---|---|---|---|---|---|---|---|---|---|
| Continuous ejection stability | A | A | A | A | A | A | A | A | A | A |
| Intermittent ejection stability | A | A | A | A | A | A | A | A | A | A |

TABLE 9

| Comparative Example | | 1 | 2 | 3 | 4 | 5 | 6 | 7 | 8 | 9 |
|---|---|---|---|---|---|---|---|---|---|---|
| Ink | | B-1 | B-2 | B-3 | B-4 | B-5 | B-6 | B-7 | B-8 | B-9 |
| Image | Evaluation value | 1.3 | 1.2 | 1.2 | 1.2 | 1.2 | 1.3 | 1.3 | 1.3 | 1.3 |
| density | Evaluation | A | B | B | B | B | A | A | A | A |
| Scratch | Evaluation value | 0.010 | 0.006 | 0.007 | 0.007 | 0.007 | 0.020 | 0.020 | 0.012 | 0.013 |
| resistance | Evaluation | B | A | A | A | A | B | B | B | B |

| | | | | | | | | | |
|---|---|---|---|---|---|---|---|---|---|
| Continuous ejection stability | B | A | A | A | A | B | B | B | B |
| Intermittent ejection stability | B | A | A | A | A | B | B | B | B |

TABLE 10

| Comparative Example | | 10 | 11 | 12 | 13 | 14 | 15 | 16 | 17 |
|---|---|---|---|---|---|---|---|---|---|
| Ink | | B-10 | B-11 | B-12 | B-13 | B-14 | B-15 | B-16 | B-17 |
| Image | Evaluation value | 1.1 | 1.1 | 1.2 | 1.2 | 1.1 | 1.1 | 1.3 | 1.3 |
| density | Evaluation | B | B | B | B | B | B | A | A |
| Scratch | Evaluation value | 0.011 | 0.013 | 0.017 | 0.015 | 0.012 | 0.011 | 0.021 | 0.023 |
| resistance | Evaluation | B | B | B | B | B | B | B | B |

| | | | | | | | | |
|---|---|---|---|---|---|---|---|---|
| Continuous ejection stability | B | B | B | B | B | B | B | B |
| Intermittent ejection stability | B | B | B | B | B | B | B | B |

As shown in Table 5, the inks (B-1), (B-2), and (B-3) each had a specific solvent percentage content of greater than 30% by mass. As shown in Table 9, these inks were evaluated as poor for at least one of the evaluation of image density, the evaluation of scratch resistance, and the evaluation of ejection stability. The reason thereof is thought to be that surface tension and viscosity of each ink and adjustment of the degree of aggregation of the pigment particles in drying of the ink were insufficient.

As shown in Tables 2, 5, and 6, the first unit percentage of the polymer (P-G) contained in each of the inks (B-4), (B-5), (B-10), and (B-11) was greater than 35% by mass. As shown in Tables 9 and 10, the image formed with any of the inks (B-4), (B-5), (B-10), and (B-11) had an image density of less than the desired value. The reason thereof is thought to be that the polymer (P-G) had relatively low hydrophobicity to make it difficult for the carbon black to aggregate. Scratch resistance of the image formed with use of the ink (B-10) or (B-11) was poor and ejection stability of the inks (B-10) and (B-11) from the recording head was also poor.

As shown in Tables 2, 5, and 6, the first unit percentage of the polymer (P-H) contained in each of the inks (B-6), (B-7), (B-12), and (B-13) was less than 11% by mass. As shown in Tables 9 and 10, scratch resistance of the image formed with any of the inks (B-6), (B-7), (B-12), and (B-13) was poor and ejection stability of these inks from the recording head was also poor. The reason thereof is thought to be that the polymer (P-H) had relatively high hydrophobicity to make it easy for the carbon black to aggregate. Furthermore, the image density of the image formed with use of the ink (B-12) or (B-13) was less than the desired value.

As shown in Table 5, the inks (B-8) and (B-9) did not contain the specific solvent. As shown in Table 9, scratch resistance of the image formed with either of these inks was poor and ejection stability of these inks from the recording head was also poor. The reason thereof is thought to be that these inks would dry relatively quickly.

As shown in Tables 2 and 6, the polymer (P-I) contained in each of the inks (B-14) and (B-15) included neither the second repeating unit nor the third repeating unit. As shown in Table 10, scratch resistance of the image formed with either of these inks was poor. The reason thereof is thought to be that the polymer (P-I) had weak adsorption power to the surface of the pigment with a result that the pigment particles insufficiently adhered to the recording medium. As shown in Table 10, the image density of the image formed with either of these inks was less than the desired value and ejection stability of these inks from the recording head was also poor. The reason thereof is thought to be that the polymer (P-I) had weak adsorption power to the surface of the pigment with a result that the pigment particles insufficiently dispersed in the ink.

As shown in Tables 2 and 6, the polymer (P-J) contained in each of the inks (B-16) and (B-17) did not include the fourth repeating unit. As shown in Table 10, scratch resistance of the image formed with either of these inks was poor and ejection stability of these inks from the recording head was also poor. The reason thereof is thought to be that these inks insufficiently penetrated into the recording medium. It is also thought to be that the pigment particles insufficiently dispersed in the ink.

By contrast, the inks (A-1) to (A-10) each had the following features as shown in Tables 1, 2, and 4. That is, each of these inks included the pigment, the specific polymer, the water-soluble organic solvent, and water. The water-soluble organic solvent included the specific solvent. The specific solvent percentage content was at least 10% by mass and no greater than 30% by mass. As shown in Table 8, these inks formed images with desired image density and excellent scratch resistance and were excellent in ejection stability from the recording head.

From the above, it can be determined that the ink according to the present disclosure, which encompasses the inks (A-1) to (A-10), can form images with desired image density and excellent scratch resistance and is excellent in ejection stability from a recording head.

What is claimed is:

1. An inkjet ink comprising:
a pigment;
a specific polymer;
a water-soluble organic solvent; and
water, wherein
the specific polymer includes at least one first repeating unit, at least one second repeating unit, at least one third repeating unit, and at least one fourth repeating unit,
the first repeating unit is a repeating unit derived from a monomer having a salt-forming group,
the second repeating unit is a repeating unit derived from a styrene-based monomer,
the third repeating unit is a repeating unit derived from a styrene-based macromer having a polymerizable functional group at one end thereof,
the fourth repeating unit is a repeating unit derived from nonionic acrylic acid ester or nonionic methacrylic acid ester,
the first repeating unit has a percentage content of at least 11% by mass and no greater than 35% by mass to a mass of the specific polymer,
the water-soluble organic solvent includes 1,2-pentanediol and 3-methyl-1,3-butanediol, and
a total percentage content of the 1,2-pentanediol and the 3-methyl-1,3-butanediol is at least 10% by mass and no greater than 30% by mass to a mass of the inkjet ink.

2. The inkjet ink according to claim 1, wherein
the salt-forming group is a carboxy group, and
the polymerizable functional group is a vinyl group.

3. The inkjet ink according to claim 1, wherein
the first repeating unit is represented by formula (1),
the second repeating unit is represented by formula (2),
the third repeating unit is represented by formula (3), and
the fourth repeating unit is represented by formula (4): 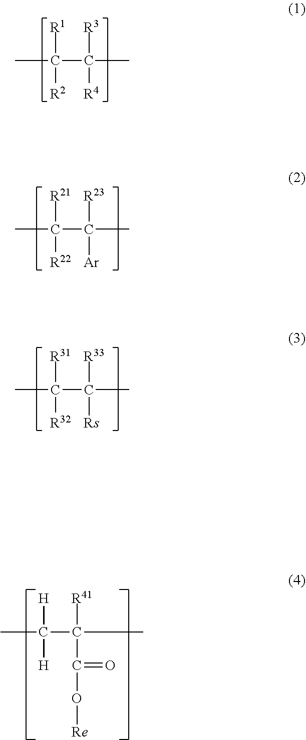
where in the formula (1), at least one of R¹, R², R³, and R⁴ each represent, independently of one another, a carboxy group or an alkyl group with a carbon number of at least 1 and no greater than 6 substituted with a carboxy group, and the rest of R¹, R², R³, and R⁴ each represents, independently of one another, a hydrogen atom or a methyl group,
in the formula (2), Ar represents a phenyl group optionally substituted with an alkyl group with a carbon number of at least 1 and no greater than 6, and R²¹, R²², and R²³ each represent, independently of one another, a hydrogen atom or a methyl group,
in the formula (3), R³¹, R³², and R³³ each represent, independently of one another, a hydrogen atom or a methyl group, and Rs represents a group having a polystyrene chain, and
in the formula (4), R⁴¹ represents a hydrogen atom or a methyl group, and Re represents a benzyl group, an alkyl group with a carbon number of at least 1 and no greater than 6, or a group having a polyoxyalkylene chain.

4. The inkjet ink according to claim 1, wherein
the second repeating unit has a percentage content of at least 10% by mass and no greater than 20% by mass to the mass of the specific polymer,
the third repeating unit has a percentage content of at least 10% by mass and no greater than 30% by mass to the mass of the specific polymer, and
the fourth repeating unit has a percentage content of at least 40% by mass and no greater than 55% by mass to the mass of the specific polymer.

5. The inkjet ink according to claim 1, wherein
the 1,2-pentanediol has a percentage content of at least 5% by mass and no greater than 15% by mass to the mass of the inkjet ink, and
the 3-methyl-1,3-butanediol has a percentage content of at least 5% by mass and no greater than 15% by mass to the mass of the inkjet ink.

6. The inkjet ink according to claim 1, wherein
a ratio of a mass of the 3-methyl-1,3-butanediol to a mass of the 1,2-pentanediol is at least 0.8 and no greater than 1.2.

7. The inkjet ink according to claim 1, wherein
the specific polymer has an octanol-water partition coefficient Log P of at least 2.0 and no greater than 4.0.

8. The inkjet ink according to claim 1, wherein
the water-soluble organic solvent has an octanol-water partition coefficient Log P of at least −0.50 and no greater than −0.10.

9. The inkjet ink according to claim 1, wherein
the specific polymer is in an emulsified particle form.
